(19) United States
(12) Patent Application Publication
(10) Pub. No.: US 2025/0323586 A1
(43) Pub. Date: Oct. 16, 2025

(54) MOTOR DRIVER

(71) Applicant: CANON KABUSHIKI KAISHA, Tokyo (JP)

(72) Inventors: YUKI TAMARI, Kanagawa (JP); KEIJI HARADA, Kanagawa (JP)

(21) Appl. No.: 19/170,155

(22) Filed: Apr. 4, 2025

(30) Foreign Application Priority Data
Apr. 11, 2024 (JP) 2024-063824

(51) Int. Cl. H02P 6/12

(52) U.S. Cl. CPC H02P 6/12

(57) ABSTRACT

One aspect of the present invention is a motor driver comprising: a monitoring unit configured to monitor a motor control signal for controlling a motor; a clocking unit configured to perform clocking in the case where a PWM duty of the motor control signal monitored by the monitoring unit does not change; a reset unit configured to reset a clocked time clocked by the clocking unit in the case where the PWM duty of the motor control signal monitored by the monitoring unit changes; a determination unit configured to determine whether the clocked time is larger than a predetermined time threshold; and a first output unit configured to output a stop signal for stopping the motor based on a determination result of the determination unit.

### FIELD

The present disclosure relates to a motor driver. In detail, the present disclosure relates to a motor driver that stops a motor by monitoring a PWM duty of a motor control signal even in a case where a watch dog timer (WDT) included in a CPU or a firmware (FW) goes into an abnormal state.

### DESCRIPTION OF THE RELATED ART

Conventionally, a WDT included in a system such a CPU or a FW that is a controller is set to prepare for the case where the CPU or the FW goes into an abnormal state. In Japanese Patent Laid-Open No. 2007-111915, a counter included in a controller clocks time in which update of PWM data is not performed, and the controller is determined to be normal in the case where this clocked time is equal to or smaller than a WDT setting value of a register, and is determined to be abnormal in the case where the clocked time exceeds the WDT setting value.

### SUMMARY

However, in the method disclosed in Japanese Patent Laid-Open No. 2007-111915, there is a possibility that a WDT function included in a system controlling a motor driver does not property operate and a motor continues to rotate in the case where the WDT function goes into the abnormal state.

Accordingly, in view of the above problem, an object of the present disclosure is to detect the abnormal state of the WDT function included in the CPU or the FW and stop the motor even in the case where the WDT function goes into the abnormal state.

One aspect of the present invention is a motor driver comprising: a monitoring unit configured to monitor a motor control signal for controlling a motor; a clocking unit configured to perform clocking in the case where a PWM duty of the motor control signal monitored by the monitoring unit does not change; a reset unit configured to reset a clocked time clocked by the clocking unit in the case where the PWM duty of the motor control signal monitored by the monitoring unit changes; a determination unit configured to determine whether the clocked time is larger than a predetermined time threshold; and a first output unit configured to output a stop signal for stopping the motor based on a determination result of the determination unit.

Further features of the present invention will become apparent from the following description of exemplary embodiments with reference to the attached drawings.

### BRIEF DESCRIPTION OF THE DRAWINGS

FIGS. 1A and 1B are diagrams illustrating a configuration of a printer unit in a first embodiment;

FIG. 2 is a block diagram of a motor control circuit in the first embodiment;

FIG. 3 is a block diagram of a first H bridge control unit in the first embodiment;

FIG. 4 is a flowchart of a process executed by the first H bridge control unit in the first embodiment;

FIG. 5 is a timing chart of the first H bridge control unit in the first embodiment;

FIG. 6 is a block diagram of a first H bridge control unit in a second embodiment;

FIG. 7 is a flowchart of a process executed by the first H bridge control unit in the second embodiment;

FIG. 8 is a timing chart of the first H bridge control unit in the second embodiment;

FIG. 9 is a block diagram of a first H bridge control unit in a third embodiment; and

FIG. 10 is a flowchart of a process executed by the first H bridge control unit in the third embodiment.

### DESCRIPTION OF THE EMBODIMENTS

Embodiments in which a technique according to the present disclosure is applied to a multi-function inkjet printer are described below.

### First Embodiment

### <Configuration of Printer Unit>

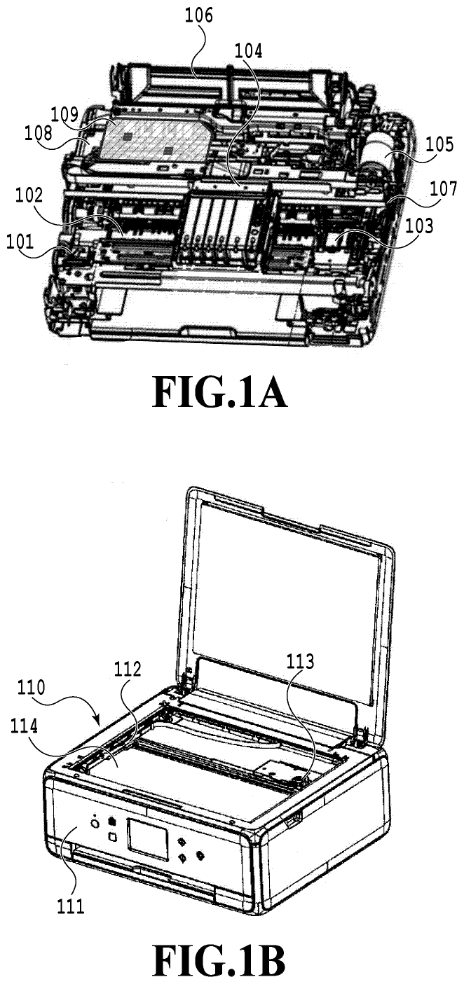

FIGS. 1A and 1B are views illustrating a configuration of a printer unit. FIG. 1A is a perspective view illustrating an internal configuration of the printer unit, and FIG. 1B is a perspective view illustrating an overall configuration of the printer unit.

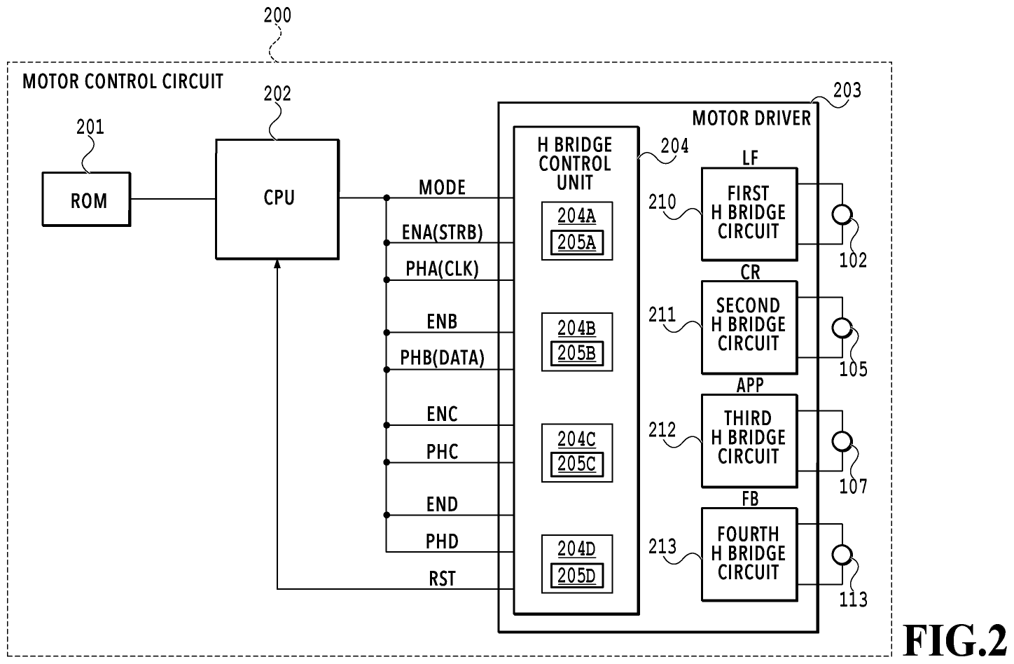

As illustrated in FIG. 1A, the printer unit includes a conveyance mechanism 101 configured to convey a print medium, an LF motor 102 configured to move the conveyance mechanism, a cleaning mechanism 103 configured to clean nozzles of a print head, and a carriage 104 configured to convey the print head. Moreover, the printer unit includes a CR motor 105 configured to move the carriage 104 and an automatic conveyance mechanism 106 configured to take one of multiple print media from top and send the print medium to the printer unit. Furthermore, the printer unit includes an APP motor 107 configured to move the cleaning mechanism 103 and the automatic conveyance mechanism 106, an AC adaptor 108, and a control circuit board 109 configured to control the entire printer in the present embodiment including a motor control circuit 200 (see FIG. 2).

FIG. 1B illustrates a state where an image reading unit 110 and a panel unit 111 are incorporated in the printer unit illustrated in FIG. 1A. The image reading unit 110 includes an image reading sensor 112, an FB motor 113 configured to move the image reading sensor 112, and a platen glass 114 on which an original is placed.

### <Configuration of Motor Control Circuit>

FIG. 2 is a block diagram illustrating detailed configurations of the above-mentioned motor control circuit 200. The motor control circuit 200 includes a ROM 201, a CPU 202, and a motor driver 203.

The motor driver 203 includes an H bridge control unit 204. The H bridge control unit 204 includes a first H bridge control unit 204A, a second H bridge control unit 204B, a third H bridge control unit 204C, and a fourth H bridge control unit 204D. The first H bridge control unit 204A includes a stop time setting register 205A, and the second H bridge control unit 204B to the fourth H bridge control unit 204D similarly include a stop time setting register 205B to a stop time setting register 205D, respectively.

Moreover, the motor driver 203 includes a first H bridge circuit 210, a second H bridge circuit 211, a third H bridge circuit 212, and a fourth H bridge circuit 213. The first H bridge circuit 210 controls the LF motor 102, the second H bridge circuit 211 controls the CR motor 105, the third H bridge circuit 212 controls the APP motor 107, and the fourth H bridge circuit 213 controls the FB motor 113.

The CPU 202 transmits motor control signals ENx and PHx (one of characters of A, B, C, and D is assigned to x. Details are described later) to the H bridge control unit 204 according to a FW stored in the ROM 201. Note that EN indicates an Enable signal, and PH indicates a Phase signal.

Moreover, the CPU 202 performs three-wire serial interface communication with the H bridge control unit 204 by using an operation mode switch signal MODE and some of the motor control signals (for example, ENA, PHA, and PHB) before driving the motors. Setting information is written to the stop time setting registers 205A to 205D by this three-wire serial interface communication. Regarding the ENA, the PHA, and the PHB, the ENA functions as a STRB, the PHA functions as a CLK, and the PHB functions as a DATA in the case where the operation mode switch signal MODE is at a Low level. In this case, the STRB is a latch signal that determines a level of the register, the CLK is a signal that determines a transfer speed of the serial communication, and the DATA is a data signal of the serial communication.

Meanwhile, in the case where the operation mode switch signal MODE is at a High level, the motor control signals function as the signals described below.

The motor control signal ENx is a binary signal indicating whether or not a current flows through the motor x. The Low level indicates that the current does not flow thorough the motor x, and the High level indicates that the current flows through the motor x. As described above, A, B, C or D is assigned to x, a motor A corresponds to the LF motor 102, a motor B corresponds to the CR motor 105, a motor C corresponds to the APP motor 107, and a motor D corresponds to the FB motor 113.

The motor control signal PHx is a PWM signal that determines revolution of the motor, a current flow direction of the motor x is determined depending on the signal level of the motor control signal PHx, and a current flow amount of the motor x is determined by a PWM duty (ratio of High level with respect to one cycle) of the motor control signal PHx. For example, an instance where the current flow direction in the case where the signal level is the Low level is CW (clockwise) and the current flow direction in the case where the signal level is the High level is CCW (counterclockwise) is discussed. In this instance, an average current flow amount to the motor x in the case where the PWM duty is 40% is 20% ((50−40)/50×100=20) in the CW direction. Meanwhile, the average current flow amount to the motor x in the case where the PWM duty is 50% is zero. Moreover, the average current flow amount to the motor x in the case where the PWM duty is 80% is 60% ((80−50)/50×100=60) in the CCW direction.

The H bridge control unit 204 performs current flow control of the LF motor 102 via the first H bridge circuit 210 based on the motor control signals ENA and PHA received from the CPU 202. The H bridge control unit 204 performs current flow control of the CR motor 105 via the second H bridge circuit 211 based on the motor control signals ENB and PHB received from the CPU 202. The H bridge control unit 204 performs current flow control of the APP motor 107 via the third H bridge circuit 212 based on the motor control signals ENC and PHC received from the CPU 202. The H bridge control unit 204 performs current flow control of the FB motor 113 via the fourth H bridge circuit 213 based on the motor control signals END and PHD received from the CPU 202.

### <Configuration of First H Bridge Control Unit>

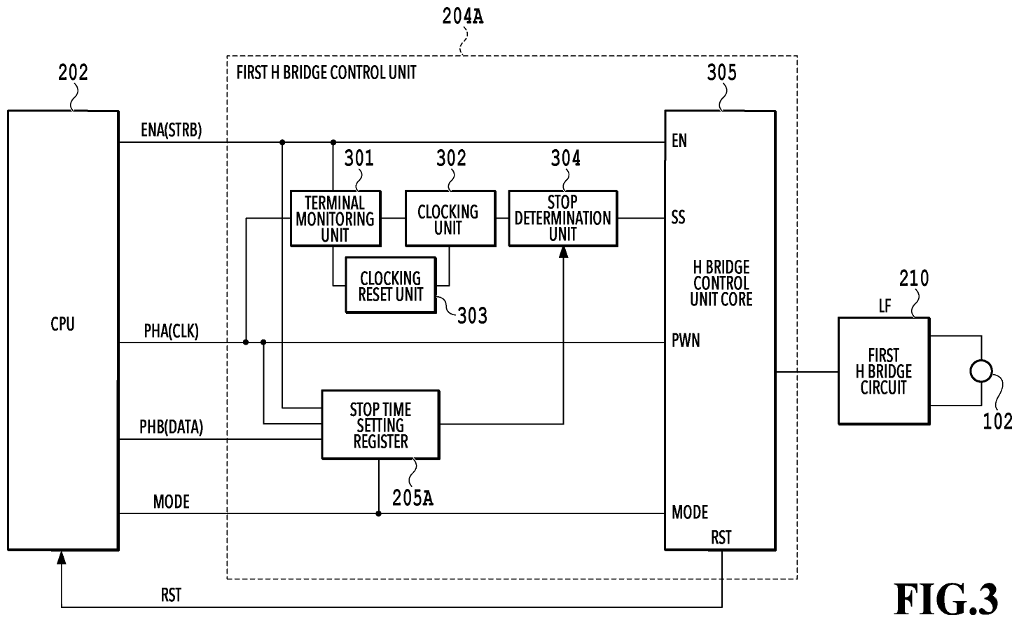

FIG. 3 is a block diagram illustrating a configuration of the first H bridge control unit 204A in the present embodiment.

First, the first H bridge control unit 204A sets a stop time in the stop time setting register 205A by using the ENA (STRB), the PHA (CLK), and the PHB (DATA) with the operation mode switch signal MODE set to the Low level (specifically, writes the setting information to the stop time setting register). For example, 60 seconds, 120 seconds, or the like can be set as the specific stop time. Next, the first H bridge control unit 204A controls the LF motor 102 based on the motor control signals ENA and PHA received from the CPU 202 with the operation mode switch signal MODE set to the High level.

A terminal monitoring unit 301 monitors the PWM duty of the PHA. In the case where this PWM duty does not change, a timer count value of a clocking unit 302 is counted up. In the case where the PWM duty changes, a clocking reset unit 303 resets the timer count value of the clocking unit 302 to zero. Moreover, in the case where the ENA is at the Low level or the PWM duty is 50%, the clocking reset unit 303 resets the timer count value of the clocking unit 302 to zero. This because, in the case where the ENA is at the Low level, the LF motor 102 is in a no-current flowing state and is thus in the stopped state, and because, in the case where the PWM duty is 50%, the average current flow amount is zero and the LF motor 102 is in the stopped state.

A stop determination unit 304 is connected to a stop signal input terminal of an H bridge control unit core 305 to be described later. In the case where the timer count value of the clocking unit 302 exceeds the stop time set in the stop time setting register 205A, the stop determination unit 304 determines that the CPU 202 or the FW is in an abnormal state in which the CPU 202 or the FW cannot update the PWM duty. The stop determination unit 304 having made this determination outputs a stop signal SS at a High level to the stop signal input terminal of the H bridge control unit core 305. In the case where the received stop signal SS is at the High level, the H bridge control unit core 305 turns off power supply to the LF motor 102 via the first H bridge circuit 210 to stop the LF motor 102.

Then, the H bridge control unit core 305 outputs a reset signal RST to the CPU 202. In the case where the CPU 202 receives the reset signal RST, the CPU 202 restores an internal circuit to an initial setting.

### <Process Executed by First H Bridge Control Unit>

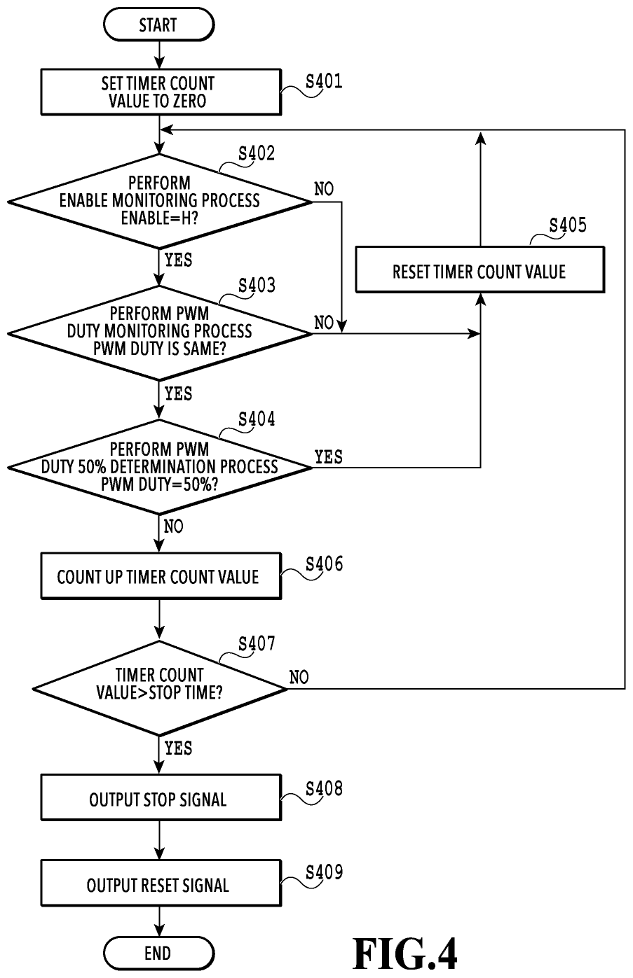

FIG. 4 is a flowchart of a process executed by the first H bridge control unit 204A.

In step S401, the first H bridge control unit 204A sets the timer count value of the clocking unit 302 to zero. In detail, the first H bridge control unit 204A sets the operation mode switch signal MODE to the Low level, and enables a clocking enable setting register (not illustrated) configured to set a function of the clocking unit 302 to enabled or disabled by using the ENA (STRB), the PHA (CLK), and the PHB (DATA). The timer count value of the clocking unit 302 is thereby set to zero. Note that “step S” is abbreviated as “S” in the following explanation.

In S402, the terminal monitoring unit 301 performs an Enable monitoring process in which the Enable signal is monitored. Specifically, the terminal monitoring unit 301 determines whether the ENA is at the High level. In the case where the determination result of the present step is true, the process proceeds to S403. Meanwhile, in the case where the determination result of the present step is false, the process proceeds to S405.

In S403, the terminal monitoring unit 301 performs a PWM duty monitoring process. Specifically, the terminal monitoring unit 301 determines whether the PWM duty is the same (in other words, the PWM duty does not change). In the case where the determination result of the present step is true, the process proceeds to S404. Meanwhile, in the case where the determination result of the present step is false (in other words, the PWM duty changes), the process proceeds to S405.

In S404, the terminal monitoring unit 301 performs a PWM duty 50% determination process. Specifically, the terminal monitoring unit 301 determines whether the PWM duty is 50%. In the case where the determination result of the present step is true, the process proceeds to S405. Meanwhile, in the case where the determination result of the present step is false, the process proceeds to S406.

In S405, the clocking reset unit 303 resets the timer count value of the clocking unit 302 to zero, and then returns to the Enable monitoring process (S402).

In S406, the CPU 202 counts up the timer count value of the clocking unit 302.

In S407, the stop determination unit 304 compares the timer count value of the clocking unit 302 with the stop time set in the stop time setting register 205A, and determines whether the timer count value is larger than the stop time. In the case where the determination result of the present step is true, the process proceeds to S408. Meanwhile, in the case where the determination result of the present step is false, the process returns to S402. Note that the stop time used in the determination process of the present step is also referred to as “time threshold”.

In S408, the stop determination unit 304 assumes that the CPU 202 or the FW is in the abnormal state in which the CPU 202 or the FW cannot update the PWM duty, and sets the stop signal SS to the High level. As a result of the present step, the H bridge control unit core 305 turns off the power supply to the LF motor 102 via the first H bridge circuit 210 to stop the LF motor 102.

In S409, the H bridge control unit core 305 outputs the reset signal RST to the CPU 202.

### <Timing Chart of First H Bridge Control Unit 204A>

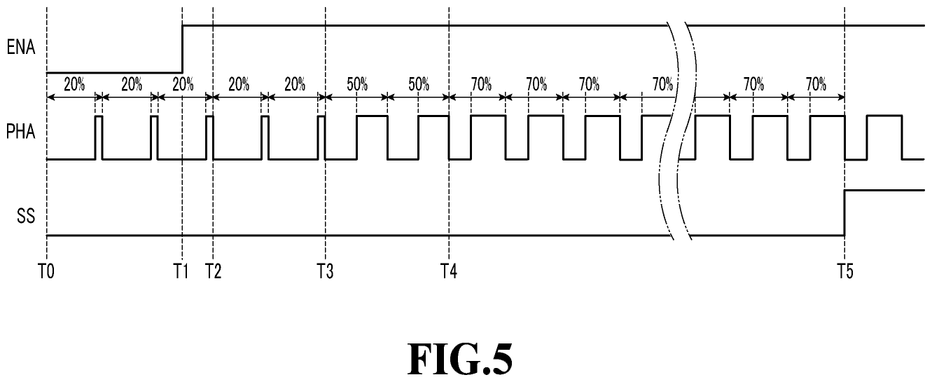

FIG. 5 illustrates a timing chart of the first H bridge control unit 204A. Since the ENA is at the Low level from a time point T0 to a time point T1, the clocking reset unit 303 resets the timer count value of the clocking unit 302 to zero. Since the PWM duty of the PHA is 20% and does not change from a time point T2 to a time point T3, the timer count value of the clocking unit 302 is counted up. Since the PWM duty of the PHA is 50% from a time point T3 to a time point T4, the clocking reset unit 303 resets the timer count value of the clocking unit 302 to zero.

Since the PWM duty of the PHA is 70% after the time point T4, the timer count value of the clocking unit 302 is counted up. Then, at a time point T5 at which the timer count value exceeds the stop time set in the stop time setting register 205A, the stop determination unit 304 determines that the CPU 202 or the FW is in the abnormal state in which the CPU 202 or the FW cannot update the PWM duty. Next, the stop determination unit 304 having made this determination outputs the stop signal SS at the High level to the H bridge control unit core 305. As a result, the H bridge control unit core 305 turns off the power supply to the LF motor 102 via the first H bridge circuit 210 to stop the LF motor 102.

The terminal monitoring unit 301 monitors the PWM duty of the PHASE signal among the motor control signals, and the timer count value of the clocking unit 302 is counted up in the case where the PWM duty does not change. In the case where the timer count value exceeds the stop time set in the stop time setting register 205A, the stop determination unit 304 outputs the stop signal SS at the High level to the H bridge control unit core 305. In this case, the H bridge control unit core 305 turns off the power supply to the LF motor 102 to stop the LF motor 102. This enables stopping of the motor even in the abnormal state in which the CPU 202 or the FW cannot update the PWM duty, and the safety is improved.

Note that, although the operation of the first H bridge control unit 204A for the first H bridge circuit 210 is explained in this section as described above, operations of the other H bridge control units are also the same. Since the operations of the second H bridge control unit 204B to the fourth H bridge control unit 204D for the second H bridge circuit 211 to the fourth H bridge circuit 213 are the same as that of the first H bridge control unit 204A, explanation thereof is omitted.

### Second Embodiment

In the first embodiment, description is given of the case where the technique of the present disclosure is applied to the method of performing the current flow amount control of the DC motor by using the PWM duty of the PHASE signal among the motor control signals, that is so-called PHASE chopping method. Meanwhile, in the present embodiment, description is given of the case where the technique of the present disclosure is applied to a method of performing the current flow control of the DC motor by using a PWM duty of the motor control signal ENA, that is so-called ENABLE chopping method.

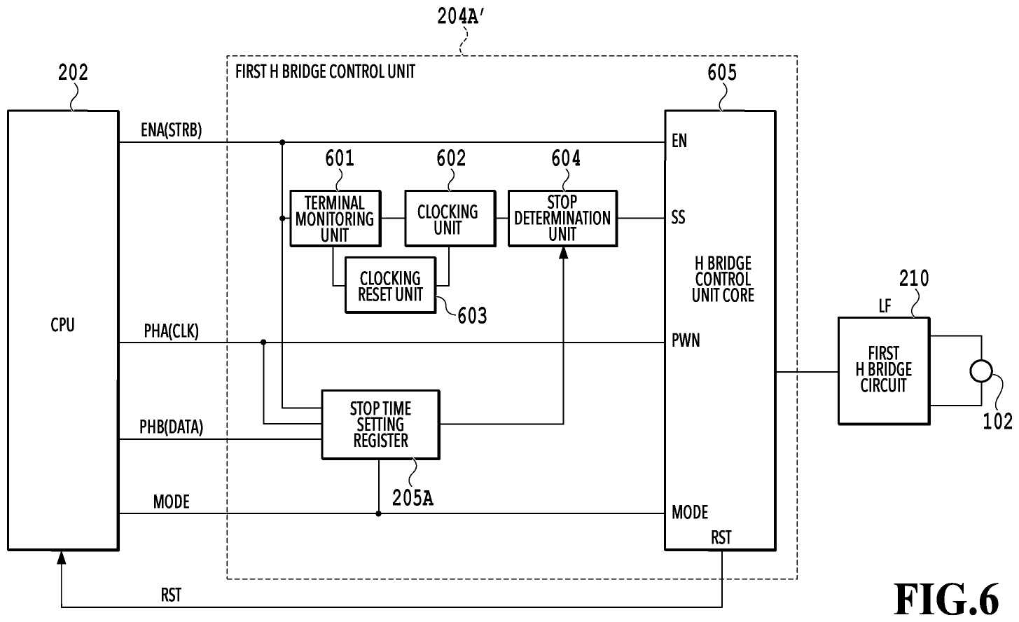

FIG. 6 is a block diagram illustrating a configuration of a first H bridge control unit 204A′ in the present embodiment. In this case, the first H bridge control unit 204A′ is a version of the first H bridge control unit 204A in the first embodiment corresponding to the ENABLE chopping. In the above-mentioned first H bridge control unit 204A, the terminal monitoring unit 301 monitors the PWM duty of the motor control signal PHA. Meanwhile, in the first H bridge control unit 204A′ of the present embodiment, a terminal monitoring unit 601 monitors the PWM duty of the motor control signal ENA.

Like the first H bridge control unit 204A described above, the first H bridge control unit 204A′ sets the stop time in the stop time setting register 205A, and controls the LF motor 102 via the first H bridge circuit 210 based on the motor control signals ENA and PHA received from the CPU 202.

The terminal monitoring unit 601 monitors the PWM duty of the ENA. In the case where the PWM duty does not change, a timer count value of a clocking unit 602 is counted up. In the case where the PWM duty changes, a clocking reset unit 603 resets the timer count value of the clocking unit 602 to zero. Moreover, in the case where the PWM duty is 0%, the clocking reset unit 603 resets the timer count value of the clocking unit 602 to zero. This is because, in the case where the PWM duty is 0%, the LF motor 102 is in the no-current flowing state and is thus in the stopped state.

A stop determination unit 604 is connected to a stop signal input terminal of an H bridge control unit core 605 to be described later. In the case where the timer count value of the clocking unit 602 exceeds the stop time set in the stop time setting register 205A, the stop determination unit 604 determines that the CPU 202 or the FW is in the abnormal state in which the CPU 202 or the FW cannot update the PWM duty. The stop determination unit 604 having made this determination outputs the stop signal SS at the High level to the stop signal input terminal of the H bridge control unit core 605. In the case where the received stop signal SS is at the High level, the H bridge control unit core 605 turns off the power supply to the LF motor 102 via the first H bridge circuit 210 to stop the LF motor 102.

Then, the H bridge control unit core 605 outputs the reset signal RST to the CPU 202. In the case where the CPU 202 receives the reset signal RST, the CPU 202 restores the internal circuit to the initial setting.

### <Process Executed by First H Bridge Control Unit>

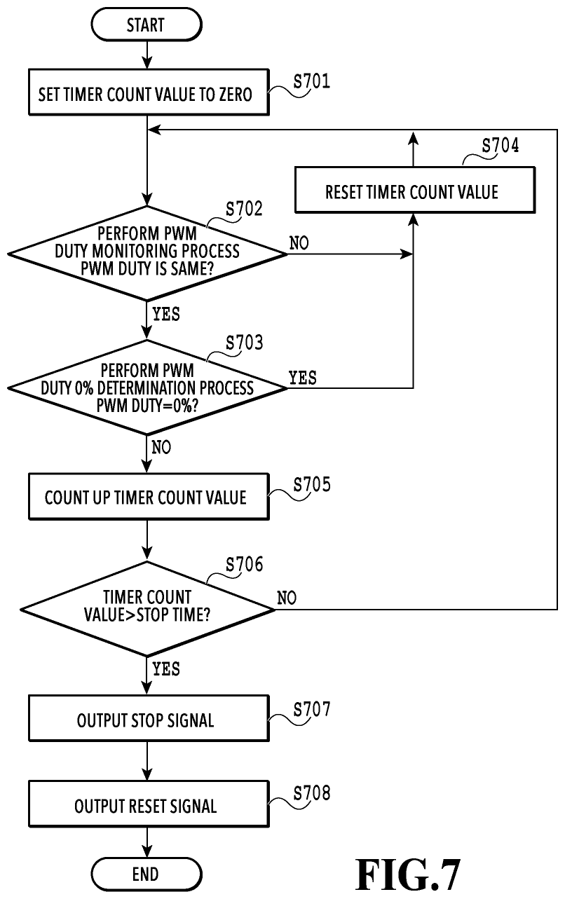

FIG. 7 is a flowchart of a process executed by the first H bridge control unit 204A′.

In step S701, the first H bridge control unit 204A′ sets the timer count value of the clocking unit 602 to zero. In detail, the first H bridge control unit 204A′ sets the operation mode switch signal MODE to the Low level. Then, the first H bridge control unit 204A′ enables a clocking enable setting register (not illustrated) configured to set a function of the clocking unit 602 to enabled or disabled by using the ENA (STRB), the PHA (CLK), and the PHB (DATA). The timer count value of the clocking unit 302 is thereby set to zero.

In S702, the terminal monitoring unit 601 performs the PWM duty monitoring process. Specifically, the terminal monitoring unit 601 determines whether the PWM duty is the same (in other words, the PWM duty does not change). In the case where the determination result of the present step is true, the process proceeds to S703. Meanwhile, in the case where the determination result of the present step is false (in other words, the PWM duty changes), the process proceeds to S704.

In S703, the terminal monitoring unit 601 performs a PWM duty 0% determination process. Specifically, the terminal monitoring unit 601 determines whether the PWM duty is 0%. In the case where the determination result of the present step is true, the process proceeds to S704. Meanwhile, in the case where the determination result of the present step is false, the process proceeds to S705.

In S704, the clocking reset unit 603 resets the timer count value of the clocking unit 602 to zero, and then returns to the PWM duty monitoring process (S702).

In S705, the CPU 202 counts up the timer count value of the clocking unit 602.

In S706, the stop determination unit 604 compares the timer count value of the clocking unit 602 with the stop time set in the stop time setting register 205A, and determines whether the timer count value is larger than the stop time. In the case where the determination result of the present step is true, the process proceeds to S707. Meanwhile, in the case where the determination result of the present step is false, the process returns to S702.

In S707, the stop determination unit 604 assumes that the CPU 202 or the FW is in the abnormal state in which the CPU 202 or the FW cannot update the PWM duty, and sets the stop signal SS to the High level. As a result of the present step, the H bridge control unit core 605 turns off the power supply to the LF motor 102 via the first H bridge circuit 210 to stop the LF motor 102.

In S708, the H bridge control unit core 605 outputs the reset signal RST to the CPU 202.

### <Timing Chart of First H Bridge Control Unit 204A′>

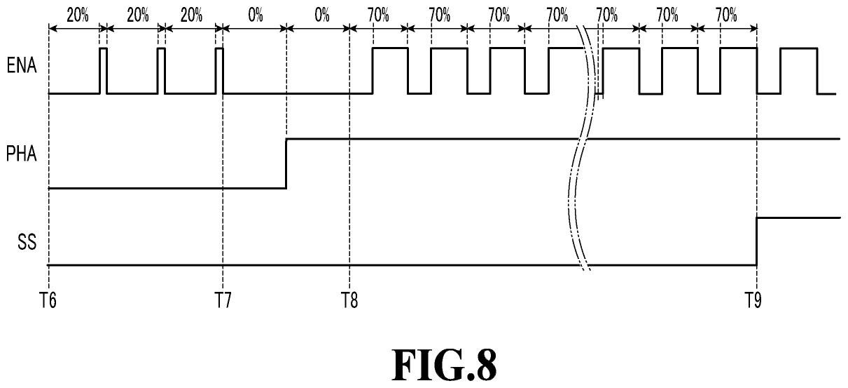

FIG. 8 illustrates a timing chart of the first H bridge control unit 204A′. Since the PWM duty of the ENA is 20% and does not change from a time point T6 to a time point T7, the timer count value of the clocking unit 602 is counted up. Since the PWM duty of the ENA is 0% from a time point T7 to a time point T8, the clocking reset unit 603 resets the timer count value of the clocking unit 602 to zero.

Since the PWM duty of the ENA is 70% after the time point T8, the timer count value of the clocking unit 602 is counted up. Then, at a time point T9 at which the timer count value exceeds the stop time set in the stop time setting register 205A, the stop determination unit 604 determines that the CPU 202 or the FW is in the abnormal state in which the CPU 202 or the FW cannot update the PWM duty. Next, the stop determination unit 604 having made this determination outputs the stop signal SS at the High level to the H bridge control unit core 605. As a result, the H bridge control unit core 605 turns off the power supply to the LF motor 102 via the first H bridge circuit 210 to stop the LF motor 102.

Note that, although the operation of the first H bridge control unit 204A′ for the first H bridge circuit 210 in the Enable chopping method is explained in this section as described above, operations of the other H bridge control units are also the same. Since operations of H bridge control units (not illustrated) for the second H bridge circuit 211 to the fourth H bridge circuit 213 are the same as that of the first H bridge control unit 204A′, explanation thereof is omitted.

### Third Embodiment

In the present embodiment, explanation is given of a configuration in which an H bridge control unit includes two different stop time setting registers. Such a configuration can be applied to both of the PHASE chopping method and the ENABLE chopping method described in the first embodiment and the second embodiment. Note that, in this section, the case where the configuration is applied to the PHASE chopping method is explained as a representative example.

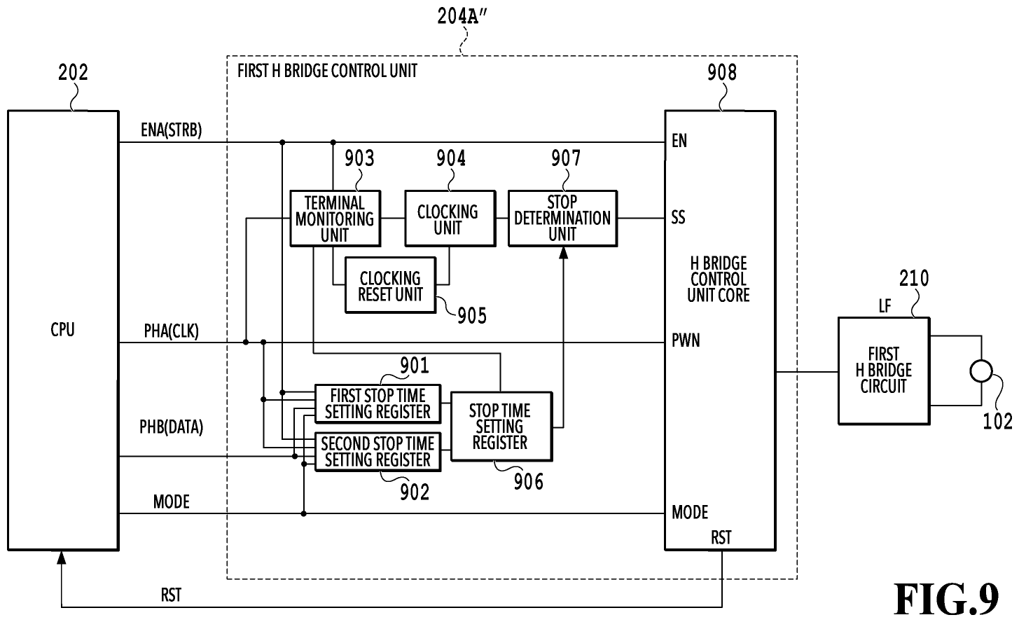

FIG. 9 is a block diagram illustrating a configuration of a first H bridge control unit 204A″ in the present embodiment, specifically, the first H bridge control unit 204A″ including two different stop time setting registers.

First, the first H bridge control unit 204A″ sets stop times in the two different stop time setting registers by using the ENA (STRB), the PHA (CLK), and the PHB (DATA) with the operation mode switch signal MODE set to the Low level (in other words, writes the setting information to the stop time setting registers). Note that, in the present embodiment, the two different stop time setting registers are described as a first stop time setting register 901 and a second stop time setting register 902. As specific stop times to be set in the stop time setting registers, for example, it is possible to set a stop time of 120 seconds or the like in the first stop time setting register 901 and set a stop time of 60 seconds or the like in the second stop time setting register 902. Next, the first H bridge control unit 204A″ controls the LF motor 102 based on the motor control signals ENA and the PHA received from the CPU 202 with the operation mode switch signal MODE set to the High level.

A terminal monitoring unit 903 monitors the PWM duty of the PHA. In the case where this PWM duty does not change, a timer count value of a clocking unit 904 is counted up. In the case where the PWM duty changes, a clocking reset unit 905 resets the timer count value of the clocking unit 904 to zero. Moreover, in the case where the ENA is at the Low level or the PWM duty is 50%, the clocking reset unit 905 resets the timer count value of the clocking unit 904 to zero. This because, in the case where the ENA is at the Low level, the LF motor 102 is in the no-current flowing state and is thus in the stopped state, and because, in the case where the PWM duty is 50%, the average current flow amount is zero and the LF motor 102 is in the stopped state.

A stop time setting unit 906 can apply the stop time of one of the first stop time setting register 901 and the second stop time setting register 902 depending on the PWM duty of the PHA monitored by the terminal monitoring unit 903. For example, in the case where the PWM duty of the PHA monitored by the terminal monitoring unit 903 is 30% to 49% or is 51% to 70%, the stop time setting unit 906 applies the stop time 120 seconds set in the first stop time setting register 901. Meanwhile, in the case where the PWM duty of the PHA monitored by the terminal monitoring unit 903 is 0% to 29% or is 71% to 100%, the stop time setting unit 906 applies the stop time 60 seconds set in the second stop time setting register 902. This allows the stop time setting unit 906 to determine that the case where the average current flow amount to the LF motor 102 is high has a higher risk and reduce the stop time in this case.

A stop determination unit 907 is connected to a stop signal input terminal of an H bridge control unit core 908 to be described later. The case where the timer count value of the clocking unit 904 exceeds the stop time that is applied by the stop time setting unit 906 and that is set in one of the first stop time setting register 901 and the second stop time setting register 902 is discussed. In this case, the stop determination unit 907 determines that the CPU 202 or the FW is in an abnormal state in which the CPU 202 or the FW cannot update the PWM duty, and outputs the stop signal SS at the High level to the stop signal input terminal of the H bridge control unit core 908. In the case where the received stop signal SS is at the High level, the H bridge control unit core 908 turns off the power supply to the LF motor 102 via the first H bridge circuit 210 to stop the LF motor 102.

Then, the H bridge control unit core 908 outputs the reset signal RST to the CPU 202. In the case where the CPU 202 receives the reset signal RST, the CPU 202 restores the internal circuit to the initial setting.

Note that, although the configuration in which the H bridge control unit includes two different stop time setting registers is described in this section as described above, the configuration may be such that the H bridge control unit includes three or more different stop time setting registers.

### <Process Executed by First H Bridge Control Unit 240A″>

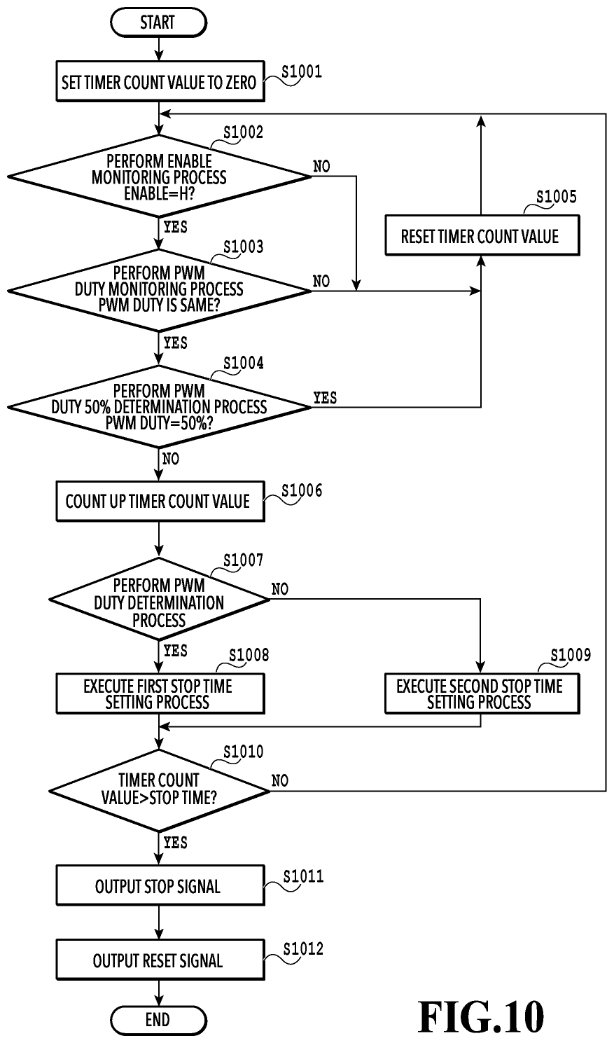

FIG. 10 is a flowchart of a process executed by the first H bridge control unit 204A″.

In step S1001, the first H bridge control unit 204A″ sets the timer count value of the clocking unit 904 to zero. In detail, the first H bridge control unit 204A″ sets the operation mode switch signal MODE to the Low level. Then, the first H bridge control unit 204A″ enables a clocking enable setting register (not illustrated) configured to set a function of the clocking unit 904 to enabled or disabled by using the ENA (STRB), the PHA (CLK), and the PHB (DATA). The timer count value of the clocking unit 904 is thereby set to zero.

In S1002, the terminal monitoring unit 903 performs the Enable monitoring process in which the Enable signal is monitored. Specifically, the terminal monitoring unit 903 determines whether the ENA is at the High level. In the case where the determination result of the present step is true, the process proceeds to S1003. Meanwhile, in the case where the determination result of the present step is false, the process proceeds to S1005.

In S1003, the terminal monitoring unit 903 performs the PWM duty monitoring process. Specifically, the terminal monitoring unit 903 determines whether the PWM duty is the same (in other words, the PWM duty does not change). In the case where the determination result of the present step is true, the process proceeds to S1004. Meanwhile, in the case where the determination result of the present step is false (in other words, the PWM duty changes), the process proceeds to S1005.

In S1004, the terminal monitoring unit 903 performs the PWM duty 50%

determination process. Specifically, the terminal monitoring unit 903 determines whether the PWM duty is 50%. In the case where the determination result of the present step is true, the process proceeds to S1005. Meanwhile, in the case where the determination result of the present step is false, the process proceeds to S1006.

In S1005, the clocking reset unit 905 resets the timer count value of the clocking unit 904 to zero, and then returns to the Enable monitoring process (S1002).

In S1006, the CPU 202 counts up the timer count value of the clocking unit 904.

In S1007, the stop time setting unit 906 performs a PWM duty determination process. Specifically, the stop time setting unit 906 determines whether the PWM duty of the PHA monitored by the terminal monitoring unit 903 is within a predetermined range. In this case, the predetermined range is, for example, 30% to 49%, 51% to 70%, or the like. In the case where the determination result of the present step is true, the process proceeds to S1008. Meanwhile, in the case where the determination result of the present step is false, the process proceeds to S1009.

In S1008, the stop time setting unit 906 executes a process (referred to as first stop time setting process) in which the stop time set in the first stop time setting register 901 is applied.

In S1009, the stop time setting unit 906 executes a process (referred to as second stop time setting process) in which the stop time set in the second stop time setting register 902 is applied. Note that the second stop time is shorter than the first stop time.

In S1010, the stop determination unit 907 compares the timer count value of the clocking unit 904 with the stop time set in the first stop time setting register 901 or the second stop time setting register 902, and determines whether the timer count value is larger than the stop time. In the case where the determination result of the present step is true, the process proceeds to S1011. Meanwhile, in the case where the determination result of the present step is false, the process returns to S1002.

In S1011, the stop determination unit 907 assumes that the CPU 202 or the FW is in the abnormal state in which the CPU 202 or the FW cannot update the PWM duty, and sets the stop signal SS to the High level. As a result of the present step, the H bridge control unit core 908 turns off the power supply to the LF motor 102 via the first H bridge circuit 210 to stop the LF motor 102.

In S1012, the H bridge control unit core 908 outputs the reset signal RST to the CPU 202.

As explained above, the stop time setting unit 906 performs a process of determining whether the PWM duty of the PHA monitored by the terminal monitoring unit 903 is within the predetermined range, as the PWM duty determination process. Then, the stop time setting unit 906 applies the first stop time in the case where the PWM duty is within the predetermined range, and applies the second stop time in the case where the PWM duty is outside the predetermined range. This allows the stop time setting unit 906 to determine that the case where the average current flow amount to the motor 102 is high has a high risk and reduce the stop time depending on the PWM duty. Accordingly, the safety is improved.

Note that, although the operation of the first H bridge control unit 204A″ for the first H bridge circuit 210 is explained in this section as described above, operations of other H bridge control units are also the same. Since the operations of the H bridge control units (not illustrated) for the second H bridge circuit 211 to the fourth H bridge circuit 213 are the same as that of the first H bridge control unit 204A″, explanation thereof is omitted.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present disclosure enables detection of the abnormal state of the WDT function included in the CPU or the FW and stopping of the motor even in the case where the WDT function goes into the abnormal state. Accordingly, the safety is improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-063824, filed Apr. 11, 2024, which is hereby incorporated by reference wherein in its entirety.

What is claimed is:

1. A motor driver comprising:
a monitoring unit configured to monitor a motor control signal for controlling a motor;
a clocking unit configured to perform clocking in a case where a PWM duty of the motor control signal monitored by the monitoring unit does not change;
a reset unit configured to reset a clocked time clocked by the clocking unit in a case where the PWM duty of the motor control signal monitored by the monitoring unit changes;
a determination unit configured to determine whether the clocked time is larger than a predetermined time threshold; and
a first output unit configured to output a stop signal for stopping the motor based on a determination result of the determination unit.

2. The motor driver according to claim 1, wherein the predetermined time threshold is a stop time set in a register.

3. The motor driver according to claim 2, further comprising a second output unit configured to output a reset signal to a CPU after output of the stop signal by the first output unit.

4. The motor driver according to claim 3, wherein, in the case where the determination unit determines that the clocked time is larger than the predetermined time threshold, the first output unit outputs the stop signal.

5. The motor driver according to claim 4, wherein the reset unit resets the clocked time also in the case where the PWM duty of the motor control signal monitored by the monitoring unit does not change, depending on the PWM duty.

6. The motor driver according to claim 5, wherein
the monitoring unit monitors a PWM duty of a phase signal in the motor control signal and an enable signal in the motor control signal,
the reset unit resets the clocked time in a case where the enable signal monitored by the monitoring unit is at a Low level, and
the reset unit resets the clocked time in a case where the enable signal monitored by the monitoring unit is at a High level and the PWM duty of the motor control signal monitored by the monitoring unit is 50%.

7. The motor driver according to claim 5, wherein
the monitoring unit monitors a PWM duty of a phase signal in the motor control signal, and
the reset unit resets the clocked time in a case where the PWM duty of the motor control signal monitored by the monitoring unit is 0%.

8. The motor driver according to claim 6, further comprising:
a first register in which a first stop time is set as the stop time;
a second register in which a second stop time is set as the stop time; and
a stop time setting unit configured to apply one of the first stop time and the second stop time as the predetermined time threshold depending on the PWM duty of the motor control signal monitored by the monitoring unit.

9. The motor driver according to claim 8, wherein
in a case where the PWM duty of the motor control signal monitored by the monitoring unit is within a predetermined range, the stop time setting unit applies the first stop time as the predetermined time threshold, and
in a case where the PWM duty of the motor control signal monitored by the monitoring unit is not within the predetermined range, the stop time setting unit applies the second stop time as the predetermined time threshold.

10. The motor driver according to claim 9, wherein the first stop time is longer than the second stop time.
